(19) United States
(12) Patent Application Publication
(10) Pub. No.: US 2005/0249886 A1
(43) Pub. Date: Nov. 10, 2005

(54) Method of making a corrosion-resistant non-stick coating

(76) Inventor: Molly Mo Hui Ge, Arlington Heights, IL (US)

Correspondence Address: DINSMORE & SHOHL LLP;One Dayton Centre, Suite 500, One South Main Street, Dayton, OH, 45402-2023, US

(21) Appl. No.: 10/839,826

(22) Filed: May 6, 2004

(51) Int. Cl. B32B 9/00

(52) U.S. Cl. 427/446; 428/421; 428/472

(57) ABSTRACT

A method of making a corrosion-resistant, non-stick coating having extended life for foodware. The method includes providing a foodware substrate having a food-contacting surface; roughening the food-contacting surface of the foodware substrate; depositing a continuous ceramic coating by vapor deposition over the roughened food-contacting surface, the continuous ceramic coating selected from nitride or carbonitride compounds of a metal selected from titanium, aluminum, chromium, zirconium, or alloys thereof; and depositing a non-stick coating over the continuous ceramic coating. The invention also relates to foodware made by the method.

### BACKGROUND OF THE INVENTION

The invention relates generally to non-stick coatings, and more particularly to a method of making a corrosion-resistant, non-stick coating having extended life for foodware, and to foodware made by the method.

The use of non-stick coatings, for example polytetrafluoroethylene (PTFE), for foodware is well known. However, PTFE is easily scratched. Attempts have been made to improve the scratch resistance of PTFE coatings by applying a hard abrasion-resistant layer underneath the PTFE, such as by thermal spraying such a coating prior to depositing the PTFE thereover. This has improved the scratch resistance of the PTFE coatings.

For example, U.S. Pat. No. 5,411,771 discloses applying a mechanically resistant layer of copper, zinc, nickel, chromium, aluminum, carbon steel, or stainless steel on a roughened surface by electrical arc spraying. A lubricative coating, such as a PTFE coating, which can be made of a primer coating, a top coating, and a clear coating, is sprayed on the mechanically resistant layer. The mechanically resistant layer is mechanically bonded solid particles, which do not create a continuous film.

U.S. Pat. No. 6,080,496 describes roughening the surface of cookware by mechanically spraying the surface with aluminum oxide, applying an abrasion resistant layer of substantially pure titanium, titanium oxide, and/or titanium nitride by thermal spraying, and applying a lubricative layer over the mechanically resistant layer. The mechanically resistant layer formed by thermal spraying is not generally a contiguous or integral layer, but is a pattern of droplets or particles sprayed on the surface.

Non-continuous abrasion resistant layers allow the non-stick coatings to penetrate through the gaps between the particles and deposit directly on the surface of the substrate of the cookware. As a result, the non-stick coatings can break down due to corrosion between the substrate metal and the thermally sprayed layer (galvanic corrosion) or due to cooking food with a high acid content (such as tomatoes) at high cooking temperatures (electrolytic corrosion). Corrosion reduces the life of the non-stick coating.

Therefore, there is a need for a corrosion-resistant, non-stick coating having extended life, and for methods of making such coatings.

### SUMMARY OF THE INVENTION

The present invention meets this need by providing a method of making a corrosion-resistant, non-stick coating having extended life for foodware. The method includes providing a foodware substrate having a food-contacting surface; roughening the food-contacting surface of the foodware substrate; depositing a continuous ceramic coating by vapor deposition over the roughened food-contacting surface; and depositing a non-stick coating over the continuous ceramic coating. By “foodware,” I mean cookware, food preparation pieces including cutlery and other manual food processing pieces (such as colanders, strainers, and the like), food serving pieces (such as plates, bowls, and the like), and utensils for eating food. By “cookware,” I mean pots and pans for stovetop cooking, bakeware, griddles, grills, cooking utensils (such as spoons, spatulas, and the like), and food preparation devices that are used to cook food (such as electric frying pans, rice cookers, and the like). By “over,” I mean next to, but not necessarily directly next to; there could be intervening layers.

Another aspect of the invention is corrosion-resistant, non-stick foodware having extended life. The foodware includes a roughened food-contacting surface of a foodware substrate; a continuous vapor-deposited ceramic coating over the roughened food-contacting surface of the foodware substrate; and a non-stick coating over the continuous ceramic coating.

### BRIEF DESCRIPTION OF THE DRAWINGS

FIG. 1 illustrates a chamber for cathodic arc vapor deposition of a continuous ceramic coating according to the present invention.

FIG. 2 is a schematic cross-section of foodware showing one embodiment of a coating made according to the present invention.

FIG. 3 is a schematic cross-section of foodware showing another embodiment of a coating made according to the present invention.

### DETAILED DESCRIPTION OF THE INVENTION

The present invention provides a method of making foodware having a corrosion-resistant, non-stick coating having extended life. The foodware has a roughened food-contacting surface over which a continuous ceramic coating is deposited by vapor deposition. A non-stick coating is deposited over the continuous ceramic coating.

The roughened food-contacting surface of the foodware substrate can be prepared by a number of processes such as mechanical roughening using blasting, arc spray, plasma arc spray, and others as are well known in the art.

The continuous ceramic coating is a hard, corrosion-resistant coating. The vapor-deposited ceramic coating is a dense, continuous film. The continuous ceramic coating completely covers the roughened food-contacting surface of the foodware substrate. It forms a barrier between the foodware substrate and the non-stick coating, isolating the non-stick coating from the substrate. The elimination of galvanic and electrolytic corrosion reduces the possible break-down of the non-stick coating, which extends its life.

The continuous ceramic coating basically maintains the profile of the roughened surface. When the non-stick coating is applied over the continuous ceramic coating, a thick layer of non-stick coating fills the valleys of the surface, providing good non-stick performance. A thin layer of non-stick coating is applied over the peaks on the surface. The continuous ceramic coating may have a hardness of at least about 65 Rc, typically in the range of about 70 Rc to about 90 Rc. The hard ceramic coating underneath the thin non-stick coating provides improved scratch- or scuff-resistance. This further extends the life of the non-stick coating.

Suitable ceramic coatings include, but are not limited to, nitrides and carbonitrides of metals including, but not limited to, titanium, aluminum, chromium, zirconium, or alloys thereof. (Ti,Al)N is one desirable ceramic coating due to its high oxidation resistance and abrasion resistance. It has a microhardness between about 2600 and about 3000 HV, 0.05, depending on the vapor deposition process used. It also has high thermal stability, with a maximum working temperature of up to about 1450° F. Because chromium nitride has mechanical and corrosion resistance complementary to (Ti,Al)N, (Ti,Al,Cr)N is another outstanding thermally stable, scratch-resistant, corrosion-resistant coating.

The non-stick coating can be any type of non-stick coating. Suitable non-stick coatings include, but are not limited to, plastic or polymer coatings. Perflourocarbon polymers, such as polytetrafluoroethylene and/or tetrafluoroethylene resin, are suitable.

The present invention can be used with various foodware substrates, including, but not limited to, steel, stainless steel, copper, titanium, cast iron, aluminum, and multilayer substrates.

The substrate can be formed into a pan before applying the coatings.

The foodware made according to the present invention demonstrates outstanding corrosion resistance. In addition, the non-stick coating has better adhesion to the continuous ceramic coating, resulting in a longer lasting coating having better scratch resistance.

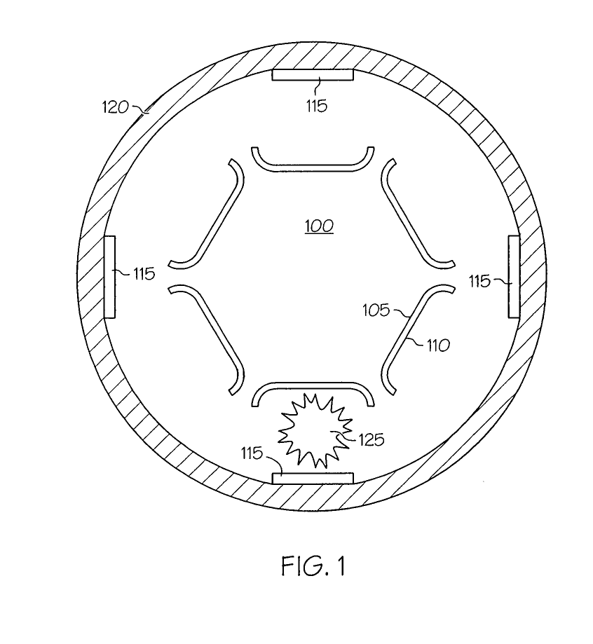

FIG. 1 shows a vacuum chamber 100 which could be used to deposit the continuous ceramic coating of the present invention. The continuous ceramic coating is deposited over the food-contacting surface of the foodware substrate after roughening and cleaning.

The vapor deposition process can be a physical vapor deposition process. Suitable vapor deposition processes include, but are not limited to, cathodic arc vapor deposition, sputtering deposition, or ion plating.

One vapor deposition process which is useful in the present invention is cathodic arc vapor deposition. In this process, the vapor source is the vaporization of the cathode 115 at a low voltage, high current electric arc in vacuum chamber 100. Several cathodes (evaporators) 115 are located on the sidewall 120 of the vacuum chamber 100. Each evaporator generates plasma from a multiplicity of arc spots, which move over a solid cathode surface. This process generates a high energy and concentrated plasma. For example, if the cathode 115 is titanium pure metal, the plasma is highly reactive, and the great percentage of the vapor is atomic and ionized (Ti⁺) 125. In cathodic arc vapor deposition, the substrate 105 is carried on a negative voltage, while the chamber wall 120 is an anode. The Ti ion is accelerated to high energy and attracted to the negative substrate surface 110 and reacts with nitrogen, forming a continuous ceramic coating of TiN on the surface 110 of substrate 105.

The substrate 105 has a food-contacting surface, which is a roughened surface 110. The surface can be roughened using a mechanical process, including, but not limited to, mechanical blasting with aluminum oxide, silicon carbide, glass beads, or other compounds. The resulting roughened surface 110 can have a surface roughness of between about 70 and about 200 micro-inches, generally about 90 to about 150 micro-inches. Alternatively, the surface can be roughened by thermal spraying, arc spraying, plasma arc spraying, or other roughening techniques, as are well known in the art.

After the roughening step is completed, the roughened surface can be cleaned with a typical cleaning solution, such as an aqueous cleaning system in conjunction with ultrasonic cleaning. The substrates can then be coated according to the present invention.

The roughened/cleaned substrate can be loaded into a suitable fixture and placed in the planetary of the deposition chamber 100, as shown in FIG. 1. The substrates 105 can be subjected to one or two-fold planetary rotation during deposition.

Appropriate targets 115 are placed in the chamber 100. For example, in one embodiment, three compressed metal powder targets of 50% titanium/50% aluminum (At %) can be used, along with one target of pure titanium. The number and type of targets will depend on the size of the chamber and the coating to be deposited, as is well known in the art.

The chamber 100 is pumped to a pressure of about 10⁻³ Pa by a vacuum pump system. The substrates 105 are heated to a temperature in the range of about 350° F. to about 450° F., depending on the type of material the substrate is made of. The substrate is then biased with a negative voltage of about 800 to about 1000V to micro-clean the substrate through a glow discharge. A bonding layer may be deposited first. The appropriate targets are ignited, for example Ti, and the substrate is bombarded with ions at a bias voltage of about 600 to about 1000V at a vacuum level of about 10⁻² Pa forming a pure titanium bonding layer. The bonding layer typically has a thickness of less than about 1 micron. The bonding layer is generally a pure metal. Suitable metals include, but are not limited to, titanium, chromium, zirconium, or alloys thereof.

After the bonding layer is deposited, the TiAl and Ti targets, or just the TiAl targets, are turned on, and nitrogen is introduced into the system to form the (Ti,Al)N coating. The applied voltage can typically be about 80 to about 200V at a vacuum level of about 0.4 to about 1.5 Pa. The deposition temperature can be raised up to about 450° F. to about 700° F. at the end of the deposition, depending on the material the substrate is made of. The total film thickness of the nitride or carbonitride ceramic coating is generally in the range of about 1 to about 10 microns, typically about 2 to about 5 microns.

The composition of the continuous ceramic coating can be the same, or there can be multi-layers having different compositions, if desired. The composition can be varied by altering the number and type of targets being used for each layer, as is well known in the art.

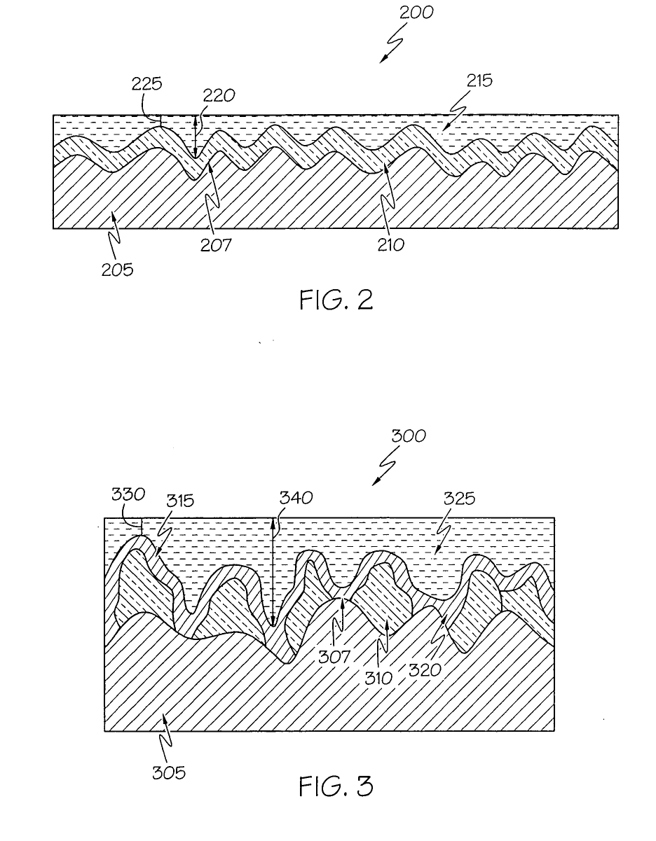

FIG. 2 is a schematic cross-section of foodware 200 showing one embodiment of the present invention. The foodware 200 has a substrate 205 which can be made from various materials, as discussed above. The substrate 205 has a roughened upper surface 207. The abrasive cleaning/surface roughening step is used to clean the upper surface, remove oxidation and contaminates, and provide a roughened surface, which promotes the adhesion of the continuous ceramic coating and helps with the performance of the non-stick coating. One method of abrasive cleaning/roughening can be performed in a blast cabinet, using different blasting materials such as aluminum oxides, silicon carbide, or glass beads, as is well known in the art.

For example, a #36 to #46 aluminum oxide can be used at a blasting pressure of about 60 to about 100 psi. The resultant upper surface 207 of substrate 205 has a surface roughness in the range of about 70 to about 300 micro-inches (Ra). The roughened surface can be cleaned by an aqueous cleaning with an ultrasonic source, and dried. The substrate can be loaded into the vapor deposition chamber for the application of the continuous ceramic coating, as described above. The continuous ceramic coating 210, such as (Ti,Al)N, fully covers the roughened upper surface 207 of the foodware. The thickness of the continuous ceramic coating can be about 1 to about 11 microns. The continuous ceramic coating basically maintains the peaks and valleys of the roughened surface 207.

The entire upper surface of peaks and valleys is fully protected from corrosion due to the high thermal stability and high corrosion resistance of the continuous ceramic film. In addition, the hard ceramic coating is a strong base for good wear resistance.

A non-stick coating 215, such as PTFE, or other lubricant, is applied over the continuous ceramic coating 210 by known methods including, but not limited to spray coating. The non-stick coating can be a multilayer PTFE coating, including, but not limited to, a primary layer, an intermediate layer, and a top layer, as is known in the art.

The non-stick coating 215 is thick in valley areas 220 and thin in peak areas 225. The continuous ceramic coating 210 creates a sealed barrier between roughened upper surface 207 and non-stick coating 215. Therefore, it eliminates the non-stick coating's breakdown due to galvanic or electrolytic corrosion, which extends the life of the foodware. The thick areas of non-stick coating 220 enhance the non-stick ability of the foodware. The thin areas 225 provide good scratch or abrasion resistance and durability as a result of the underlying hard ceramic coating 210.

FIG. 3 is a schematic cross-section of foodware 300 showing another embodiment of the present invention. The foodware 300 includes a substrate 305 with a roughened upper surface 307. The abrasive cleaning/surface roughening step was described above. Abrasive-resistant particles 310 can be applied by thermal spraying, plasma arc spraying, or other techniques, as are well known in the art. These processes deposit particles or patterned droplets on the roughened upper surface 307. However, the roughened upper surface 307 is not completely covered by the abrasive-resistant particles 310; there are gaps between the abrasive-resistant particles 310 which expose parts of the roughened upper surface 307. The roughened and thermally sprayed surface is cleaned, such as using aqueous cleaning with an ultrasonic source, then dried.

A continuous ceramic coating 320 is applied over the exposed roughened upper surface 307 and the surface 315 of the abrasive-resistant particles 310 in the same manner as previously described. A non-stick coating 325 is applied over the continuous ceramic coating 320 by a known method, as previously described.

The continuous ceramic coating 320 provides a sealed barrier between the roughened, upper surface/surface of the thermally sprayed particles 307/315 and the non-stick coating 325. It eliminates the breakdown of the non-stick coating 325 due to galvanic or electrolytic corrosion, extending the life of the foodware. The non-stick performance is enhanced by the thick areas of non-stick coating 340, and the abrasion-resistance is improved by the thin areas 330, as discussed above.

### EXAMPLE 1

Blistering tests were conducted on pans coated according to the present invention and pans which had no intermediate ceramic coating. Blistering would be an evidence of galvanic corrosion and electrolytic corrosion occurring beneath the surface of the non-stick coating.

The substrate of all of the pans was 304 stainless steel. The food-contacting surface of the pans was roughened by mechanical blasting using #46 aluminum oxide, to obtain a surface roughness of 100-120 microinches (Ra).

After roughening, one set of pans (A) was coated with a (Ti,Al)N ceramic coating having a thickness of about 3.0 microns. A PTFE coating about 25 microns thick was applied over the (Ti,Al)N ceramic coating using spray techniques, as are known in the art.

After roughening, another set of pans (B) was coated with the same 25 micron PTFE coating described above. These pans did not have an intermediate ceramic coating.

Blister Test on a Salty-Based Solution

This test involved the exposure of the coated food-contacting surface of both pans A and B to boiled salty water at a pH level of 8.0 for 16 hours. During testing, water and salt were added to maintain the concentration of the salty water.

Blister Test on Acidic-Based Solution

This test involved the exposure of the coated food-contacting surface of both pans A and B to boiled tomato sauce with water added to reach a pH of 4.5 for 16 hours. Water and tomato sauce ware added to maintain the pH level during testing.

After 16 hours cooking, all pans were taken out and washed with hot water and detergent by a soft brush to remove any adhering salt or acidic deposition, then dried. The pans were examined visually and under 100× magnification.

Pans A showed no evidence of blistering or other defects visually or under 100× magnification for either the salty-based solution or the acidic-based solution.

Pans B showed breakdown of the non-stick coating visually, and some corrosion pits were observed under 100× magnification for both the salty-based solution and the acidic-based solution.

Foodware coated according to present invention can be used for both salty-based and acidic-based food because of the improved corrosion-resistance.

While certain representative embodiments and details have been shown for purposes of illustrating the invention, it will be apparent to those skilled in the art that various changes in the compositions and methods disclosed herein may be made without departing from the scope of the invention, which is defined in the appended claims.

1. A method of making a corrosion-resistant, non-stick coating having extended life for foodware comprising:
providing a foodware substrate having a food-contacting surface;
roughening the food-contacting surface of the foodware substrate;
depositing a continuous ceramic coating by vapor deposition over the roughened food-contacting surface; and
depositing a non-stick coating over the continuous ceramic coating.

2. The method of claim 1 wherein the food-contacting surface of the foodware substrate is roughened by a process selected from mechanical roughening, thermal spraying, arc spraying, plasma arc spraying, or combinations thereof.

3. The method of claim 1 wherein the roughened food-contacting surface has a surface roughness of between about 70 to about 300 micro-inches.

4. The method of claim 1 wherein the roughened food-contacting surface has a surface roughness of between about 90 to about 150 micro-inches.

5. The method of claim 1 wherein the vapor deposition process is a physical vapor deposition process.

6. The method of claim 1 wherein the vapor deposition process is cathodic arc vapor deposition.

7. The method of claim 1 further comprising depositing a bonding layer on the roughened food-contacting surface before the continuous ceramic coating is deposited.

8. The method of claim 7 wherein the bonding layer comprises a metal selected from titanium, chromium, zirconium, or alloys thereof.

9. The method of claim 1 wherein the continuous ceramic coating has a thickness in a range of from about 1 to about 11 microns.

10. The method of claim 1 wherein the continuous ceramic coating has a thickness in a range of from about 2 to about 5 microns.

11. The method of claim 1 wherein the non-stick coating is selected from polytetrafluoroethylene, or tetrafluoroethylene resin.

12. The method of claim 1 wherein the continuous ceramic coating has a hardness of at least about 65 Rc.

13. The method of claim 1 wherein the continuous ceramic coating is selected from nitrides or carbonitrides of metals selected from titanium, aluminum, chromium, zirconium, or alloys thereof.

14. The method of claim 1 wherein the continuous ceramic coating is selected from (Ti,Al)N, (Ti,Al,Cr)N, or combinations thereof.

15. The method of claim 1 wherein the foodware substrate is selected from steel, stainless steel, copper, titanium, cast iron, aluminum, or multilayer substrates.

16. Corrosion-resistant, non-stick foodware having extended life comprising:
a roughened food-contacting surface of a foodware substrate;
a continuous vapor deposited ceramic coating over the roughened food-contacting surface of the foodware substrate; and
a non-stick coating over the continuous ceramic coating.

17. The foodware of claim 16 wherein the continuous ceramic coating has a thickness in a range of from about 1 to about 11 microns.

18. The foodware of claim 16 wherein the non-stick coating is selected from polytetrafluoroethylene, or tetrafluoroethylene.

19. The foodware of claim 16 wherein the continuous ceramic coating is selected from nitrides or carbonitrides of metals selected from titanium, aluminum, chromium, zirconium, or alloys thereof.

20. The foodware of claim 16 wherein the continuous ceramic coating is selected from (Ti,Al)N, (Ti,Al,Cr)N, or combinations thereof.

21. The foodware of claim 16 wherein the foodware substrate is selected from steel, stainless steel, copper, titanium, cast iron, aluminum, or multilayer substrates.

22. The foodware of claim 16 further comprising a bonding layer between the roughened food-contacting surface of the foodware substrate and the continuous ceramic coating.

23. The foodware of claim 22 wherein the bonding layer comprises a metal selected from titanium, chromium, zirconium, or alloys thereof.

24. The method of claim 1 wherein the non-stick coating comprises a polymer.

25. The foodware of claim 16 wherein the non-stick coating comprises a polymer.
